(19) United States
(12) Patent Application Publication
(10) Pub. No.: US 2016/0098238 A1
(43) Pub. Date: Apr. 7, 2016

(54) SYSTEM AND METHOD FOR PRINTING FROM A MOBILE COMPUTING DEVICE TO A NARROW MEDIA PRINTER

(71) Applicant: Brent Grandil, Chandler, AZ (US)

(72) Inventor: Brent Grandil, Chandler, AZ (US)

(21) Appl. No.: 14/599,527

(22) Filed: Jan. 18, 2015

Related U.S. Application Data
(60) Provisional application No. 62/060,498, filed on Oct. 6, 2014.
(60) Provisional application No. 62/067,370, filed on Oct. 22, 2014.

(51) Int. Cl. G06F 3/12

(52) U.S. Cl. CPC G06F 3/1292; G06F 3/1203; G06F 3/1247

(57) ABSTRACT

One aspect of the disclosure relates to a method for printing a document in a mobile environment, comprising: using a mobile computing device, executing a first application in the background; executing a second application in the foreground; activating, from the second program, an extension of the first application; wherein the extension facilitates conversion of a selected document having a first encoding to a second encoding, the second encoding useable to control a printer communicatively coupled to the mobile computing device via a WiFi, Bluetooth, or wired connection. The printer can be a narrow media printer, wherein, responsive to receipt of the second encoding, the narrow media printer prints the document. Additionally, the extension can facilitate re-sizing/re-formatting the selected document. In an embodiment, the first application, the second application and the extension execute within separate sandboxes.

### CROSS-REFERENCE TO RELATED APPLICATIONS

The present application claims priority of provisional applications Ser. No. 62/060,498 to Brent Grandil, entitled “MOBILE APPLICATION ENABLING INTER-APP SHARING OF DATA TO PRINT TO MOBILE DEVICES,” filed on Oct. 6, 2014; and Ser. No. 62/067,370 to Brent Grandil, entitled “EXTENSION THAT ALLOWS CONVERSION OF DOCUMENTS INTO A PRINT LANGUAGE FOR MOBILE PRINTERS,” filed on Oct. 22, 2014; each of which is incorporated herein by reference.

### BACKGROUND OF THE INVENTION

1. Field of the Invention

The present invention relates to a novel system and method for printing from a mobile computing device to a narrow media printer.

2. Description of the Related Art

Mobile computing devices such as tablet computers have become increasingly popular for business usage. Applications for Apple's tablet computer (iPad) can print using a proprietary print function provided by Apple called “Airprint” which requires that the mobile device and the printer be attached to the same local wireless network. While suitable for many business applications, Airprint does not support printing to narrow media, such as is required for label printers, barcode printers, mobile ticketing devices, etc. it also does not support Bluetooth printers.

To address this problem, some printer manufacturers provide software development kits (SDK) to allow developers to modify an application to print from a tablet computer to the manufacturer's brand of narrow media printer. However, an SDK requires extensive programming knowledge to implement, and because narrow media printers occupy a relatively small market segment, there is insufficient incentive for developers to make use of these SDKs to allow printing to narrow media printers. Moreover, there are many different narrow media printer manufacturers, each with their own SDK, making it even more difficult.

### SUMMARY OF THE INVENTION

One aspect of the disclosure relates to a method for printing a document in a mobile environment, comprising: using a mobile computing device, executing a first application in the background; executing a second application in the foreground; activating, from the second program, an extension of the first application; wherein the extension facilitates conversion of a selected document having a first encoding to a second encoding, the second encoding useable to control a printer communicatively coupled to the mobile computing device via a WiFi, Bluetooth, or wired connection. The printer can be a narrow media printer, wherein, responsive to receipt of the second encoding, the narrow media printer prints the document. Additionally, the extension can facilitate re-sizing/re-formatting the selected document. In an embodiment, the first application, the second application and the extension execute within separate sandboxes.

Another aspect of the disclosure relates to a system for printing a document in a mobile environment, comprising: a mobile computing device and a printer communicatively coupled to the mobile computing device via a short distance network; wherein the mobile computing device includes a first application executing in the background; a second application executing in the foreground; and an extension of the first application activated from the second application, the extension facilitating conversion of a selected document having a first encoding to a second encoding, the second encoding useable to control the printer.

### BRIEF DESCRIPTION OF THE DRAWINGS

FIG. 1 illustrates a mobile computing device printing to a narrow media printer, according to an embodiment;

FIG. 2 illustrates an architecture of the mobile computing device;

FIG. 3 illustrates a functional diagram of the present invention, according to an embodiment; and

FIG. 4 illustrates a flow diagram of a method of printing to a narrow media printer from a mobile computing device, according to an embodiment.

### DETAILED DESCRIPTION OF THE INVENTION

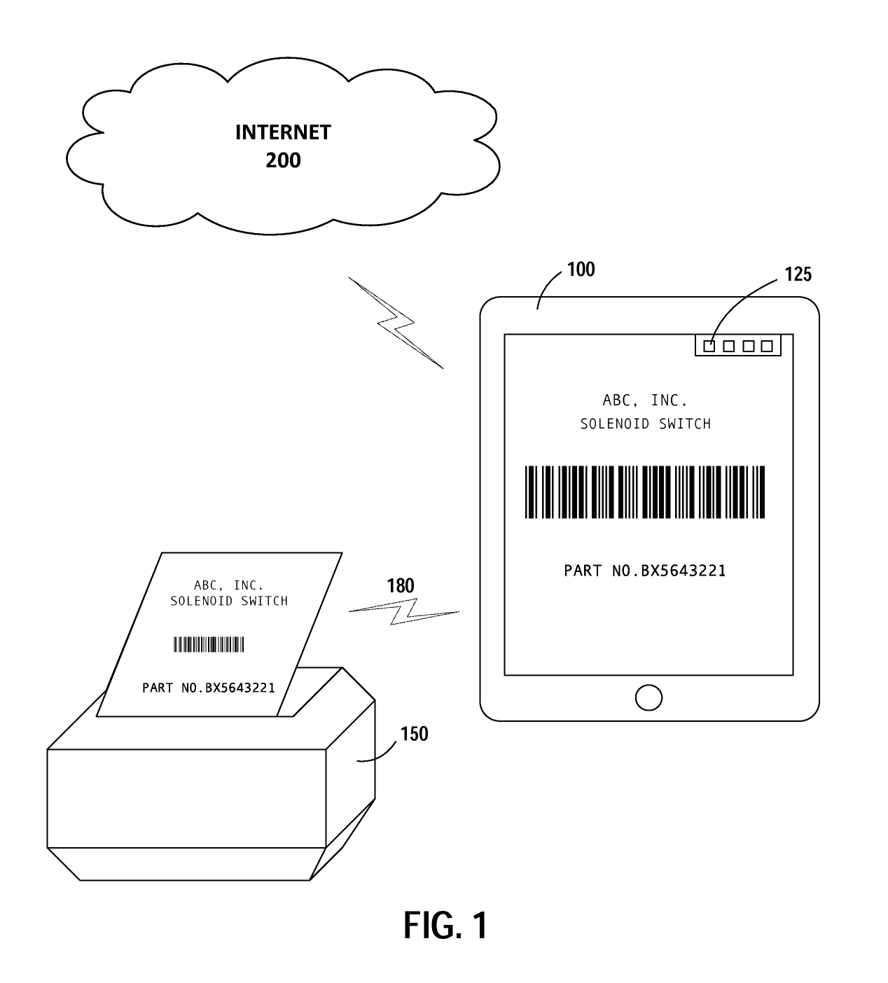

FIG. 1 illustrates a mobile computing device 100 printing to a narrow media printer 150. As shown, the mobile computing device 100 is communicatively coupled to the narrow media printer 150 via a short distance network 180. In the illustrated embodiment, the mobile computing device 100 is an Apple iPad™ computer or an Apple iPhone™. In other embodiments, the mobile computing device 100 can be a computing device using another operating system such as the “Android” operating system. In still other embodiments, the mobile computing device 100 can be a laptop computer, such as an Apple MacBook Air™ or Apple MacBook Pro™, or a desktop computer, such as an Apple iMac™. The narrow media printer 150 can be a mobile printer equipped with a microprocessor and memory, such as a Zebra™ brand printer, made by Zebra Technologies of Lincolnshire, Ill. The narrow media printer 150 prints when it receives information encoded in a supported native page description language, such as ZPL (Zebra Print Language), EPL/ELT2 (Eltron Programming Language), or CPCL (Comtec Printer Control Language). The mobile printer 150, additionally, can communicate information as to its operational status to the mobile computing device 100. The short distance network 150 can be a short distance wireless connection, such as a Bluetooth™ (which uses UHF radio waves) or a Wi-Fi connection, or a hardwired connection, for example. As will be described in greater detail, an application program executed by the mobile computing device 100 allows a user to select a document for printing to the narrow media printer 150. The document can be encoded using a first encoding scheme, such as PDF (Portable Document Format). The application program allows the document to be re-sized/re-formatted, and converted to a second encoding scheme (such as ZPL) acceptable to the narrow media printer 150. In an embodiment, the application program can access additional information, such as format templates, from the Internet 200.

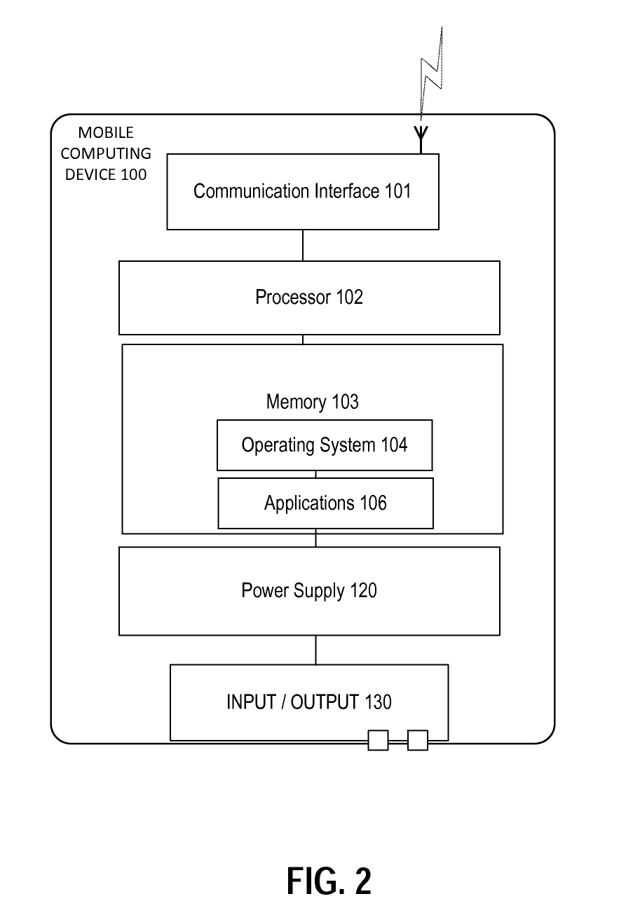

FIG. 2 illustrates an architecture of an exemplary mobile computing device 100. As shown, the mobile computing device 100 includes a communication interface 101, a processor 102, a memory 103, a power supply 120, and input/output 130. The communication interface 101 controls wireless communication with other devices via the Internet, WiFi networks, Bluetooth, etc. The communication interface 101 also includes a touchscreen that includes a LED-backlit glossy widescreen Multi-Touch display. The processor 102 can be an Apple A4 processor which has a system-on-a-chip (SOC) architecture that integrates the main processor, graphics silicon, and other functions such as a memory controller. The Apple A4 is based on a 32-bit reduced instruction set computer (RISC) instruction set architecture (ISA) developed by ARM Holdings, known as “ARM” or “Advanced RISC Machine”. The memory 103 includes 16 GB, 32 GB, or 64 GB of flash memory (depending on the model). The memory 103 includes storage for an operating system 104 and applications 106 (“apps”) which includes the software of the invention. The power supply 120 can include a rechargeable lithium-polymer battery and power charger. The input/output 130 can include various input/output devices including a digital camera, a 30-pin dock connector port, a 3.5-mm stereo headphone jack, and a built-in speaker and microphone.

The techniques of the present invention described herein can be accomplished by loading appropriate applications 106 into the memory 103 and executing the applications 106. Where the mobile computing device 100 is the Apple iPad, user inputs can be received via the touchscreen. Applications 106 for the Apple iPad can be developed using the Apple Developer Suite, including use of Xcode, Interface Builder, and iPhone Simulator development tools, or via custom programming in Objective C, for example For further information regarding programming for the Apple iPad, see, Sams Teach Yourself iPad Application Development in 24 Hours, by John Ray, Sams (Pearson Education, Inc.), 2011; and iOS 8 for Programmers: An App-Driven Approach with Swift (3rd Edition) (Deitel Developer Series), which are incorporated herein by reference. Additionally, it is to be understood that where the mobile computing device 100 is other than Apple's OSx operating system, other programming techniques and tools can be used. For example, where the mobile computing device 100 is a device such as a smartphone or tablet computer utilizing the Android operating system, an appropriate Android software development kit (SDK) can be used to provide the tools and application program interfaces (API) for developing the application 106 on the Android platform using the Java programming language. Android is an operating system based on Linux currently developed by Google, Inc.

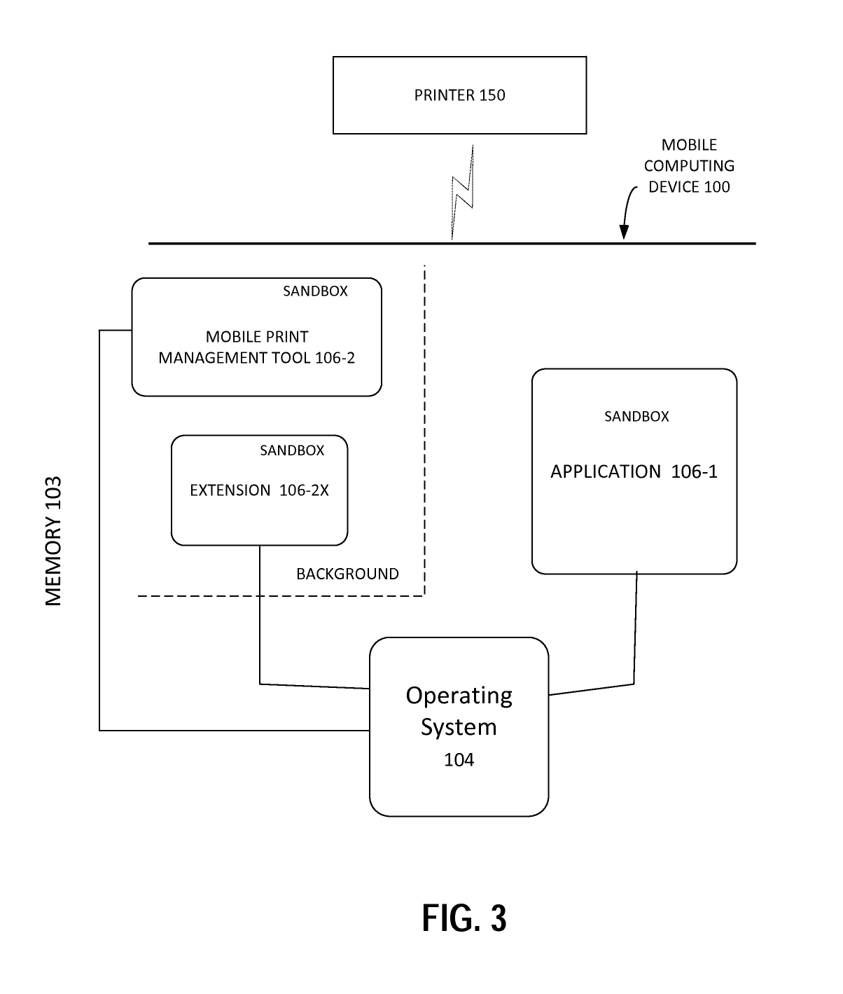

FIG. 3 illustrates a functional diagram featuring aspects of the present invention, according to an embodiment. As shown, an application 106-1 executes in the foreground of the mobile computing device 100 while another application called mobile print management tool 106-2 executes in the background, each in their respective “sandbox”, as this term is used and applied by Apple Inc. for its iOS8 system architecture. The narrow media printer 150 can be a portable printer equipped with a microprocessor and memory capable of printing to media having a width less than 5 inches (typically a width of about 3-4 inches) that prints when it receives information encoded in a native print language. Examples of suitable printers useable in conjunction with the present invention include Zebra Qln Series (models Qln220, Qln320, Qln420), Zebra QL Series (QL220, QL320, QL420) and models ZQ510, imz320, and imz220. The narrow media printer 150, preferably, can communicate information as to its operational status.

The mobile print management tool 106-2 includes an action “extension” 106-2X which is also confined to a “sandbox. As will be described in greater detail, when a user of the application 106-1 wishes to print a document, the user touches (or otherwise selects) an action extension button 125, as shown in FIG. 1 (or similar widget) to activate the extension 106-2X. Advantageously, the user does not need to open the mobile print management tool 106-2. Thus, it is easier for the user to cause a document to be printed since it can be done within the same application 106-1. The extension 106-2X operates in a sandbox which allows communication only between the mobile print management tool 106-2 and the application 106-1, facilitated by the operating system 104.

The extension 106-2X can access a library of routines that can translate documents such as a PDF into native print code interpretable by various narrow media printers 150. The extension 106-2X renders in the user's application 106-1 where it performs appropriate re-sizing encoding translations. The extension 106-2X can also access drivers of various print devices, such as the narrow media printer 150. In an embodiment, the mobile print management tool 106-2 can access the Internet 200 for drivers, format routines, licensing management, etc.

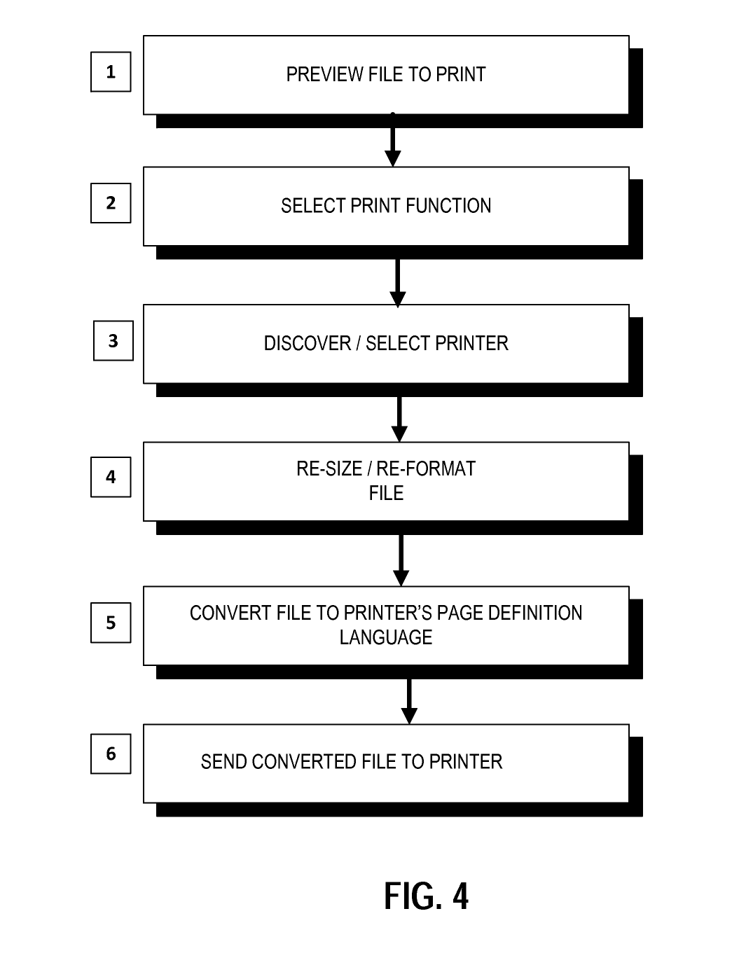

FIG. 4 illustrates a flow diagram of an exemplary method of printing to a narrow media printer from a mobile computing device, according to an embodiment. The following example is provided to clarify the subject matter of the present invention but is not meant to be limiting. This example assumes that an Apple iOS device is being used and runs under the iOSx operating system. It is further assumed that the user has already installed the mobile print management tool 106-2 (with the extension 106-2X) and the application 120 on the mobile computing device 150. The mobile print management tool 106-2 is running in the background and the extension 106-2X has been enabled.

In Step 1, using the application 106-1, a user previews a file (document) to be printed. For example, the application 106-1 could be an inventory control program which generates a bar code with product information (as shown in FIG. 1).

In Step 2, the user activates the extension 106-2X from within the application 106-1 by touching an action extension button 125. The extension 106-2X thereupon receives a request from the application 106-1. The extension 106-2X pulls the selected document (e.g., PDF, JPEG, raw print code) into the sandbox environment.

In Step 3, the extension 106-2X discovers an available set of printers on the short distance network 180. Printers can be discovered by searching through a network directory for devices with a specified manufacturer (e.g., Zebra, Citizen, Brother) and/or model id. The discovery process can include searching a multicast through IP address or hostnames on a network and then through attached external devices (e.g., Bluetooth devices). If a device found in the search matches the search criteria then it is added to a list displayed for the user to select which device to connect to. The user selects one of the available printers.

In Step 4, the extension 601-2X queries the selected narrow media printer 150 to determine the print width and resolution for the narrow media printer 150. The extension 601-2X allows the user to re-size and/or re-format the document for appropriate printing on the narrow media printer 150, if necessary. Additionally, the extension 601-2X allows the printed document to have the appropriate resolution. For many narrow media printers 150, image resolution is only 203 dpi. To accomplish the forgoing, the document can be converted to a bitmap (BMP) image. For example, if the original document is a JPEG or PDF file, this file can be converted to BMP format using an appropriate conversion utility, as is known in the art. Using an appropriate utility, the BMP can be re-sized and/or the resolution adjusted. Although conversion to a BMP image is mentioned, it is to be understood that the original document may instead be converted to another type of raster image format.

In Step 5, the extension 601-2X converts the document encoding to an encoding useable by the selected narrow media printer 150. For example, if the document opened in the application 106-1 is encoded in PDF format, after Step 4, the file would have been converted to a BMP file having the appropriate dimensions and resolution. Similarly, if the document opened in the application 106-1 is encoded in JPEG format, the file would have been converted to a BMP file having the appropriate dimensions and resolution. Conversion from BMP format to the native narrow media print language can be accomplished using various known techniques. For Zebra printers, the following ZPL code can be used:
̂FO0,0̂IMG:PRINT.BMP̂FS
   where “PRINT.BMP” is the name of the BMP file being converted to Zebra Control Language (ZPL). Alternatively, the contents of the BMP file can be substituted for the file name. In this case, the ZPL command would include the raw BMP data in place of the file name.

Additionally, it may be desirable to control various aspects of printing with supported native print language parameters. Examples include code to indicate page orientation, printer speed, and gap sensing. In these cases, it may be necessary to have information about the features supported by the selected printer, and only offer printing options where the selected printer is able to print as instructed. In a preferred embodiment, the user is able to select a set of print options using, for example, radio buttons and the appropriate native print language code can be generated corresponding to the user-selected options. In certain cases, default options can be established and the user can override one or more such default options.

In Step 6, the native narrow media print file (e.g., ZPL code) is transmitted to the selected narrow media printer 150, where it is printed. Preferably, the printing status (e.g., job printed successfully) is received by the mobile computing device 100 from the narrow media printer 150 and displayed to the user.

The present invention can operate under the Apple iOS8 operating system. However, it is to be understood that it is anticipated that the present invention will be suitable for later releases of the Apple iOSx operating system as well. Additionally, the present invention may be suitable for use with other operating systems (including those later developed).

The type of extension useable with the present invention is known in the art as an “action extension”. Such programming details are known to those skilled in the art. Routines that can be developed include those to: determine print width by an attached printer; determine the printer language; determine print characteristics based upon URL; import libraries into the extension 106-2X; determine which print language to send once the narrow media printer 150 is selected for printing; routines for continuous or multiple pages that will invert print data to make pages come out of the narrow media printer 150 in a natural way; routines to determine if memory sizes are exceeding computer manufacturer limitations; routine to check if the host application 106-1 requires multiple copies without user intervention; routine to determine print data length to eliminate extra paper; and routine to determine if a print error occurred, etc.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A method for printing a document in a mobile environment, comprising:
using a mobile computing device, the mobile computing device having a processor executing an operating system with a background and a foreground;
executing a first application in the background;
executing a second application in the foreground; and
activating, from the second application, an extension of the first application, wherein the extension facilitates conversion of a selected document having a first encoding to a second encoding, the second encoding useable to control a printer communicatively coupled to the mobile computing device.

2. The method of claim 1, wherein responsive to receipt of the second encoding, the printer prints the document.

3. The method of claim 2, wherein the printer is a wireless narrow media printer.

4. The method of claim 3, wherein the wireless narrow media printer prints using a roll of print media no more than about four inches in width.

5. The method of claim 1, wherein the extension further facilitates re-sizing the selected document.

6. The method of claim 1, wherein the extension further facilitates re-formatting the selected document.

7. The method of claim 1, wherein the first application, the second application and the extension execute within separate sandboxes.

8. The method of claim 1, wherein converting the selected document having the first encoding to the second encoding includes converting the first document to a raster image and then converting the raster image to the second encoding.

9. The method of claim 8, wherein the first encoding and the second encoding are encoded according to different page description languages.

10. The method of claim 1, wherein the printer communicatively coupled to the mobile computing device is communicatively coupled to the mobile computing device via UHF radio waves.

11. The method of claim 1, wherein the printer communicatively coupled to the mobile computing device is communicatively coupled to the mobile computing device via a wireless local network.

12. A system for printing a document in a mobile environment, comprising:
a mobile computing device, the mobile computing device having a processor executing an operating system with a background and a foreground; and
a printer communicatively coupled to the mobile computing device via a short distance network, wherein the mobile computing device includes a first application executing in the background;
a second application executing in the foreground; and
an extension of the first application activated from the second application, the extension facilitating conversion of a selected document having a first encoding to a second encoding, the second encoding useable to control the printer.

13. The system of claim 12, wherein responsive to receipt of the second encoding, the printer prints the document.

14. The system of claim 12, wherein the printer is a wireless narrow media printer.

15. The system of claim 14, wherein the wireless narrow media printer prints using a roll of print media no more than about four inches in width.

16. The system of claim 12, wherein the extension further facilitates re-sizing the selected document.

17. The system of claim 12, wherein the extension further facilitates re-formatting the selected document.

18. The system of claim 12, wherein the first application, the second application and the extension execute within separate sandboxes.

19. The system of claim 12, wherein conversion of the selected document having the first encoding to the second encoding includes conversion of the first document to a raster image and then conversion of the raster image to the second encoding.

20. The system of claim 12, wherein the first encoding and the second encoding are encoded according to different page description languages.
